(19) United States
(12) Patent Application Publication
(10) Pub. No.: US 2018/0034073 A1
(43) Pub. Date: Feb. 1, 2018

(54) COMPONENT FOR A REDOX FLOW CELL AND METHOD FOR PRODUCING A COMPONENT FOR A REDOX FLOW CELL

(71) Applicant: DLR-Institut fur Vernetzte Energiesysteme e.V., Oldenburg (DE)

(72) Inventors: Hayo Seeba, Oldenburg (DE); Timo DiNardo, Meppen (DE); Oliver Osters, Oldenburg (DE); Carolina Nunes-Kirchner, Oldenburg (DE)

(73) Assignee: DLR-Institut fur Vernetzte Energiesysteme e.V., Oldenburg (DE)

(21) Appl. No.: 15/550,129

(22) PCT Filed: Feb. 5, 2016
(86) PCT No.: PCT/EP2016/052485

§ 371 Date: Aug. 10, 2017

(30) Foreign Application Priority Data
Feb. 13, 2015 (DE) 10 2015 102 123.4

(51) Int. Cl. H01M 8/0273; H01M 8/0286; H01M 8/18

(52) U.S. Cl. CPC H01M 8/0273; H01M 8/188; H01M 8/0286

(57) ABSTRACT

The invention relates to a component for a redox flow cell, with an electrode frame (1, 11), an electrode (4, 14), a membrane (2) and a bipolar plate (3), wherein the electrode (4, 14) is arranged in the electrode frame (1, 11) and is enclosed circumferentially by the latter, and the electrode frame (1, 11) is arranged between membrane (2) and bipolar plate (3). It is essential that the electrode frame (1, 11) is connected to at least the membrane (2) in an integrally bonded manner by adhesive bonding. The invention furthermore relates to methods for producing a component for a redox flow cell.

### BACKGROUND

The invention relates to a component for a redox flow cell, and also to a method for producing a component for a redox flow cell.

Redox flow cells are used in redox flow batteries. In this case, a plurality of redox flow cells are typically interconnected electrically in series and electrolytes flow through them in parallel. In this way, energy can be both stored and released. A redox flow battery therefore has at least one component with two electrode frames, two electrodes, a membrane for ion exchange and two bipolar or end plates. The electrode is arranged in the electrode frame and is therefore circumferentially enclosed by the electrode frame. The electrode frame with the electrode is arranged between membrane and bipolar plate.

During operation, an electrolyte typically flows through the electrode by the electrolyte being supplied and discharged via lines which are formed in the electrode frame.

A redox flow battery of this kind is known from T. Shigematsu, “Redox Flow Battery for Energy Storage”, Sei Technical Review, Number 73, October 2011, pp. 4-13, in particular according to FIGS. 2 and 3 and the associated description.

Due to the complexity of such systems of electrochemical cell combinations, implementation in industrial manufacturing processes is made difficult. Similarly, servicing is complicated.

### SUMMARY

The present invention is therefore based on the object of providing a component for a redox flow cell and also a method for producing a component for a redox flow cell, which component and method reduce the risk of faulty cells and in this way facilitate implementation in industrial manufacturing processes.

This object is achieved by a component for a redox flow cell described below and also by a method for producing a component for a redox flow cell. Advantageous refinements of the component can be found in the description below. Advantageous refinements of the method can be found in the description below. The content of all of the claims is hereby explicitly included in the description by reference.

The component according to the invention for a redox flow cell is preferably produced by the method according to the invention, in particular a preferred embodiment of said method. The method according to the invention is preferably designed to produce a component according to the invention, in particular a preferred embodiment of said component.

The invention is based on the knowledge that redox flow cells are multicomponent systems through which the electrolyte flows under pressure, and therefore a large number of seals are required in redox flow batteries according to the prior art. Similarly, an arrangement, for example, of the electrode on the electrode frame or between two electrode frames with an accurate fit is necessary, and there may therefore also be considerable fault sources here.

The component according to the invention for a redox flow cell has an electrode frame, an electrode, a membrane, and a bipolar plate. The electrode is arranged in the electrode frame and is circumferentially surrounded by said electrode frame. The electrode frame is arranged between membrane and bipolar plate. A substructure of this kind is also known, in principle, in redox flow batteries from the prior art. The component is therefore at least in the form of a half-cell.

It is important that the electrode frame is cohesively connected to at least the membrane by adhesive bonding.

This results in considerable advantages in comparison to previously known redox flow cells since no seal is required in the region of the cohesive connection between electrode frame and membrane since the cohesive connection between electrode frame and membrane considerably simplifies the assembly of a redox flow battery and therefore enables implementation of industrial manufacturing processes and since a cohesive connection is less risky in respect of leaks in comparison to the use of a conventional seal and therefore the probability of failure and the complexity of servicing are reduced. Furthermore, the cohesive connection between membrane and electrode frame allows the use of smaller membrane areas compared with a physically identical redox flow cell using conventional seals. However, the costs of a redox flow cell are significantly determined (typically to approximately 20%) by the costs of the membrane, and therefore a saving in material of the membrane leads to a considerable cost reduction.

In addition, a more compact structure is possible due to the cohesive connection of the membrane to the electrode frame since, for example, a layer system membrane/electrode frame with cohesive connection can be realized more thinly compared to the use of a seal between membrane and electrode frame.

The cohesive connection between electrode frame and at least membrane by adhesive bonding has further advantages:
If the focus is directed at an industrial production process, it is clear that a large amount of working time and a large reduction in costs are possible by it being possible for adhesive to be applied in a fully automated manner. This is true of adhesives of all kinds. However, in particular, processing of adhesive films, as described further below, can be realized as an extremely efficient process, in particular preferably as a roll-to-roll process, in which the joining parts to be adhesively bonded are semi-continuously joined by roll nips. Furthermore, these advantages arise particularly when using a viscous structure adhesive, in particular an adhesive or a plurality of adhesives based on one or more elements from the group comprising epoxy resin, acrylates, polyurethane, silicone, silane-modified polymers.
A completely bonded stack allows external bracing to be reduced or even dispensed with. This leads to a reduction in the required components and therefore to a reduction in the costs and also the weight of the overall stack. In addition, costs can be saved due to quicker assembly (amongst other things due to the smaller number of components). Furthermore, adhesive bonding of a stack allows the use of extremely cost-effective materials since the reduced compression or lack of compression allows mechanically lower-quality materials to be used (in the case of intense compression, many customary plastics tend to flow plastically).
Materials which are not accessible for a thermal joining method can be joined by adhesives. The applicability to non-weldable materials can relate, for example, to electrode frames.
Different materials can be joined to one another by adhesive bonding. In contrast to welding, not only are thermoplastics not required but materials with the same or at least similar melting points are not required either. The material requirements are therefore less stringent.
The joining parts are not exposed to any high temperatures, and therefore no material distortion occurs and there are no changes in properties/degradation phenomenon.
It is possible to connect very thin components (advantageous in respect of saving material and weight and as a result cost savings). On the other hand, welding, for example, usually has a comparatively small joining region and is generally not applicable when the starting material is very thin (little material).
An adhesive connection can simultaneously act as a seal. Adhesive connections allow a cohesive connection to all components of a redox flow stack. In addition, large-area connections and therefore seals which are considerably more fault-tolerant are possible.
The mechanical force distribution with respect to the area of an adhesively bonded joint which is subjected to loading is usually considerably greater than a welded connection. This in turn can lead to components of smaller dimensions and therefore in turn to a saving in materials and costs.

In the method according to the invention for producing a component for a redox flow cell, an electrode frame with an electrode is arranged between a membrane and a bipolar plate. It is important that the electrode frame is cohesively connected at least to the membrane by adhesive bonding. This results in the abovementioned advantages.

The abovementioned advantages occur to an even greater extent when, in a preferred refinement of the component according to the invention, the electrode frame is additionally cohesively connected to the bipolar plate, preferably by adhesive bonding. In this way, the advantages of simple handleability, in particular in respect of simplified assembly when producing a stack comprising a plurality of cells, the more compact construction and the increased safety of a liquid-tight connection are therefore also transferred to the connection between electrode frame and bipolar plate.

Therefore, in the case of the method according to the invention, the electrode frame is preferably additionally cohesively connected to the bipolar plate, preferably by adhesive bonding.

However, it is particularly advantageous for the cohesive connection between electrode frame and/or bipolar plate to be formed by adhesive bonding. In this way, a stable, permanently fluid-tight, cohesive connection can firstly be achieved in a simple manner. Furthermore, simple implementation in industrial manufacturing techniques is possible in this way by applying an adhesive to one or to both elements to be joined and then pressing the two elements against one another, in particular compressing said two elements.

However, membrane-friendly methods are preferably used, in particular methods which do not have a heating effect and in particular do not melt the membrane. In this case, cohesive connection by adhesive bonding provides further advantages since no heat or only a small amount of heat is introduced into the materials to be adhesively bonded during the adhesive bonding process.

In this case, it lies within the scope of the invention to form the cohesive connection by adhesive bonding using an adhesive process technique, in particular using an automatic dispenser, spraying or doctoring an adhesive or by transfer adhesive bonding. In particular, the adhesives used can be physically binding adhesives and/or chemically curing adhesives and/or adhesive adhesives.

The use of an adhesive film for forming the cohesive connection is particularly advantageous. An adhesive film allows simple handling. In particular, the adhesive film can advantageously be formed in the desired areal shape for the cohesive connection in advance, so that a cohesive connection can be formed in the desired regions in a simple, fault-tolerant manner.

In a further preferred embodiment of the component according to the invention, a liquid-tight seal is formed between electrode frame and membrane, at least apart from one or more channels for supplying and/or discharging a liquid electrolyte to/from an electrode, by the cohesive connection. In this preferred embodiment, the cohesive connection between membrane and electrode frame is therefore of substantially encircling form, possibly with regions being cut out for the inflow and/or outflow of an electrolyte between electrode frame and membrane to the electrode.

However, line paths for feeding and draining the liquid electrolyte to/from the membrane can be particularly preferably formed in the electrode frame, so that an encircling, in particular completely encircling, liquid-tight cohesive connection is formed between electrode frame and membrane in this particularly preferred refinement.

As a result, the use of additional seals, at least between electrode frame and membrane, is superfluous.

This advantage is preferably also transferred to the connection between electrode frame and bipolar plate by, in a further preferred embodiment, a liquid-tight seal being formed between electrode frame and bipolar plate, at least apart from one or more channels for supplying and/or discharging a liquid electrolyte to/from the electrode, by the cohesive connection. In this case too, it is particularly advantageous for lines for supplying and/or discharging the electrolyte to be formed in the electrode frame, and for an encircling, in particular completely encircling, liquid-tight cohesive connection to be formed between electrode frame and bipolar plate. A considerable advantage in that a seal between electrode frame and bipolar plate can be dispensed with arises in this case too.

Therefore, the electrode frame can particularly advantageously be formed with the membrane and also with the bipolar plate, in each case by a completely encircling, liquid-tight cohesive connection, preferably by adhesive bonding, so that no further seal is required between these components in any case.

As mentioned in the introductory part, the costs, in particular the material costs, of the membrane make up a considerable proportion of the total costs of a redox flow cell. It is therefore advantageous when the membrane only slightly overlaps the frame in an encircling manner. With respect to the extent of the frame, it is advantageous, for the same reasons, when the membrane overlaps the frame in the direction of the length and in the direction of the width by less than 15%, preferably by less than 10%, further preferably by less than 5%, with respect to the length and, respectively, width of the frame. Given typical dimensions of redox flow cells, it is advantageous that the membrane overlaps the frame in an encircling manner by less than 2 cm, further preferably by less than 1.5 cm, in particular by less than 1 cm.

A refinement of this kind of the membrane is particularly advantageous in conjunction with the above-described encircling cohesive connection between membrane and electrode frame.

The cohesive connection of at least electrode frame and membrane and preferably additionally of electrode frame and bipolar plate allows the arrangement of the electrode within the electrode frame, without a cohesive connection of the electrode with the electrode frame and/or without compression of the electrode between electrode frame and membrane or between electrode frame and bipolar plate. As a result, the production sequence is simplified. Irrespective of this, a contact pressure is preferably achieved between electrode and bipolar plate in order to form highly conductive electrical contact by the electrode having a greater thickness in the uninstalled state than the distance between bipolar plate and membrane in the installed state.

Therefore, the electrode is preferably arranged in the component in such a way that the electrode is held solely by an interlocking connection laterally by the electrode frame and perpendicularly to a flat extent of the electrode firstly by the bipolar plate and secondly by the membrane, in particular is held in an interlocking manner.

In a further preferred embodiment, a fully integrated individual cell is formed. To this end, a component according to the invention is formed with the bipolar plate as first bipolar plate, the electrode frame as first electrode frame, the electrode as first electrode and the membrane additionally with at least one second electrode frame and one second electrode. This fully integrated individual cell has a layer structure with directly or indirectly arranged elements in the order first bipolar plate, first electrode frame with first electrode, membrane, second electrode frame with second electrode. Furthermore, a cohesive connection is formed at least between first bipolar plate and first electrode frame, between first electrode frame and membrane and also between membrane and second electrode frame. In this case, it lies within the scope of the invention to provide adhesive between first and second electrode frame, wherein the membrane is pressed into the adhesive. Similarly—in particular when thicker membranes are used—it is possible, as an alternative or in addition, to use adhesive on both sides in edge regions of the membrane for connection to the first electrode frame on the one hand and to the second electrode frame on the other hand. In a further preferred embodiment, a bipolar plate or an end plate is finally attached to the second electrode frame, in particular preferably adhesively applied.

A fully integrated individual cell of this kind has the advantage that a plurality of such fully integrated individual cells can be formed in a first step. An integrated cell combination can then be formed in a simple manner which can be realized by industrial manufacturing techniques by the second electrode frame of a fully integrated individual cell being arranged on the bipolar plate of an adjacent fully integrated individual cell and in this way it being possible for a layer structure comprising a plurality of fully integrated individual cells which are arranged in series to be realized in a simple manner.

The above-described refinement of the fully integrated individual cells has the advantage that fully integrated individual cells of identical design can be arranged one on the other and therefore a cell combination can be formed with identical elements lined up in a manner which is less complicated in respect of process technology.

In an alternative refinement, the fully integrated individual cell is additionally formed with a second bipolar plate. The second bipolar plate is indirectly or preferably directly arranged on that side of the second electrode frame which is averted from the membrane, and is preferably cohesively connected to the second electrode frame. This fully integrated individual cell which is extended in such a way therefore has the advantage that a termination is formed on both sides by a bipolar plate in each case, so that easier handling is possible.

In order to form a cell combination, intermediate elements are additionally formed which each comprise a first electrode frame with a first electrode, a membrane and a second electrode frame with a second electrode. These elements are indirectly or preferably directly formed in the layer sequence first electrode frame with first electrode, membrane, second electrode frame with second electrode. In order to produce a cell combination, an intermediate element is then in each case arranged between two fully integrated individual cells, extended as described above, so that the intermediate element, on both sides, adjoins a bipolar plate of the respectively adjacent extended fully integrated individual cell. For the purpose of simpler handling, at least the elements first electrode frame, membrane and second electrode frame are also preferably cohesively connected to one another.

In this case, it lies within the scope of the invention to arrange the above-described fully integrated individual cells on one another—possibly with the interposition of the intermediate elements—and to compress said individual cells in a manner which is known per se, for example using threaded rods as are known from the prior art. This has the advantage that, firstly, by releasing the compression, for example by releasing the threaded rods, servicing is possible, but considerably fewer individual parts have to be handled in the process on account of the fully integrated individual cells with the above-described cohesive connections. An important advantage when using fully integrated individual cells is therefore simple servicing and replacement if a cell exhibiting a poor capacity or malfunction is identified in the battery. Therefore, it is not necessary to replace the entire stack. This is particularly advantageous in comparison to a cell with conventional seals.

In particular, seals for forming a liquid-tight seal, particularly preferably O-ring seals, are advantageously used in this case in the regions in which the fully integrated individual cell adjoin one another without cohesive connection, that is to say in particular between second electrode frames of a first fully integrated individual cell and bipolar plate of an adjacent, second fully integrated individual cell.

A particularly cost-effective refinement for production arises in this case by, in a preferred embodiment, the individual cells being arranged one on the other with interposition of an adhesive and, in a common method step, the individual cells being cohesively connected to one another, preferably by adhesive bonding.

A plurality of, in particular all of, the abovementioned cohesive connections are preferably formed by adhesive bonding.

The adhesive used is preferably a viscous structure adhesive, in particular an adhesive or a plurality of adhesives based on one or more elements from the group comprising epoxy resin, acrylates, polyurethane, silicone, silane-modified polymers. In particular, adhesives of this kind can be applied in an efficient and cost-effective manner in industrial production processes by (fully) automatic dispensers.

The adhesive film used is preferably a carrier film which is coated with adhesive on both sides. In this case, an acrylate-based adhesive is preferably used. A suitable carrier film is, in particular, a plastic film.

### BRIEF DESCRIPTION OF THE DRAWINGS

Further preferred features and embodiments are described below with reference to exemplary embodiments and the figures, in which:

FIG. 1 shows a first exemplary embodiment of two components for a redox flow cell with a common membrane, wherein the electrodes are not illustrated;

FIG. 2 shows the exemplary embodiment according to FIG. 1 with electrodes illustrated;

FIG. 3 shows a sectional illustration according to section line A in FIG. 1;

FIG. 4 shows a sectional illustration according to section line B in FIG. 1; and

FIG. 5 shows a sectional illustration according to section line C in FIG. 2.

### DETAILED DESCRIPTION OF THE PREFERRED EMBODIMENTS

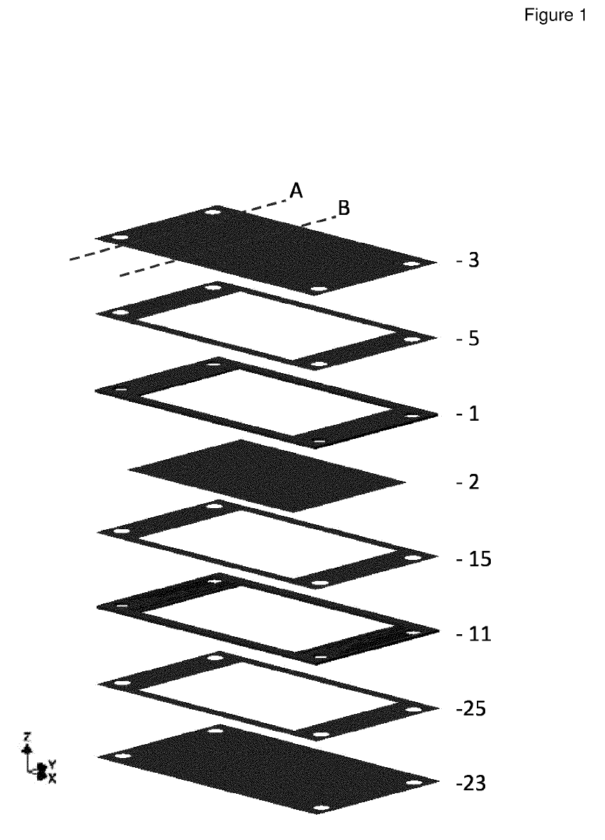

All of the figures show schematic illustrations. In FIGS. 1 to 5, identical reference symbols denote identical or identically acting elements.

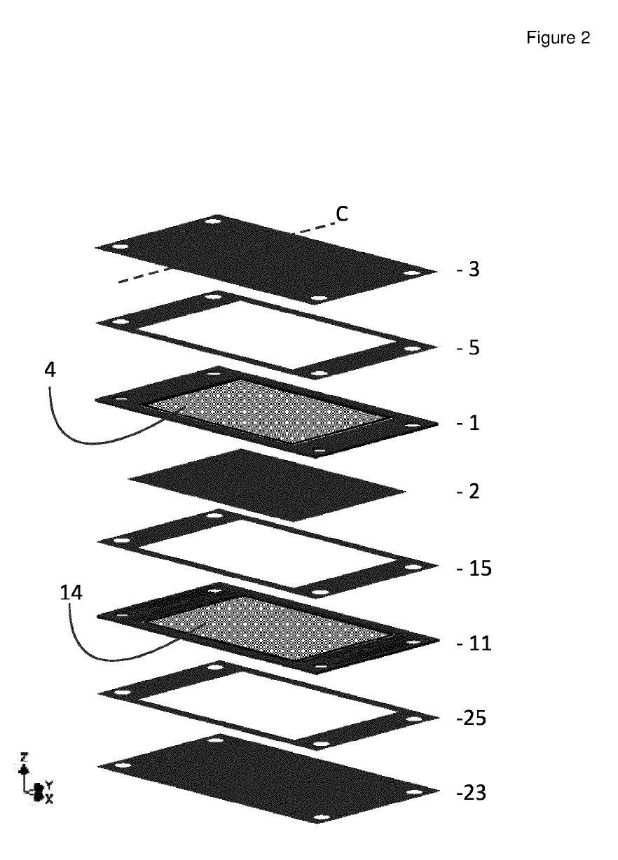

FIGS. 1 and 2 show exploded illustrations in a perspective view in order to be able to better illustrate the arrangement and configuration of the individual layers.

FIG. 1 shows an exploded illustration of an exemplary embodiment of a component according to the invention for a redox flow cell. This component comprises an electrode frame 1, a membrane 2 and a bipolar plate 3. The electrode frame has a cutout in order to accommodate an electrode. This is shown in FIG. 2 by the electrode 4 which is in the form of a felt electrode.

The electrode 4 is therefore circumferentially enclosed by the electrode frame 1. Furthermore, the electrode frame 1 is arranged between membrane 2 and bipolar plate 3.

The electrode frame 1 is connected to the bipolar plate 3 in an interlocking manner by an adhesive film 5. This also provides a liquid-tight connection between electrode frame 1 and bipolar plate 3, so that an electrolyte, which is supplied to the electrode 4 by lines (not illustrated) which are formed in the electrode frame 1 during use, therefore cannot escape between electrode frame 1 and bipolar plate 3. The adhesive film 5 therefore performs the function of the threaded rods, customary in the prior art, in respect of the arrangement of the bipolar plate 3 on the electrode frame 1 and furthermore the function of the O-ring seal, customary in the prior art, between electrode frame 1 and bipolar plate 3.

A fully integrated individual cell is furthermore formed with the component according to FIG. 1 by a second electrode frame 11 and a second electrode 14 additionally being provided:

The fully integrated individual cell therefore has the bipolar plate 3 as first bipolar plate, the electrode frame 1 as first electrode frame and the membrane 2 and additionally the second electrode frame 11 with second electrode 14 as illustrated in FIG. 2.

In addition to the cohesive connection already described above of the first electrode frame 1 to the bipolar plate 3 by the adhesive film 5 as first adhesive film, the second electrode frame 11 is furthermore cohesively connected to the membrane 2 by a second adhesive film 15.

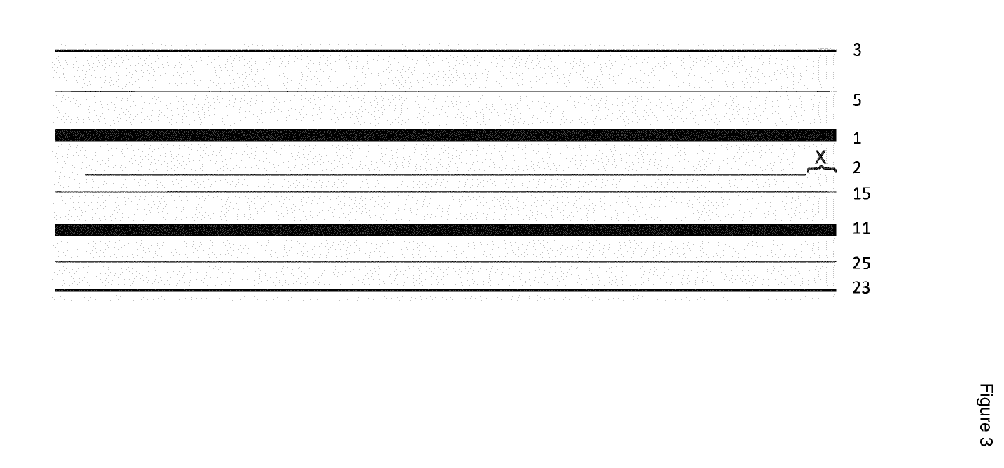

The membrane 2 only slightly overlaps both the electrode frame 11 and the electrode frame 1, in particular by less than 10% both in the direction of the length (x-direction) with respect to the length of the frame and also in the direction of the width (y-direction) with respect to the width of the frame, as will be explained in greater detail below in relation to FIGS. 3 to 5.

In this way, the second adhesive film 15 fulfills the function both of cohesively connecting the first electrode frame 1 to the second electrode frame 11 and also of cohesively connecting the membrane 2 to the second electrode frame 11. Overall, the membrane 2 is also fixedly connected to the first electrode frame 1 in this way.

Furthermore, the second adhesive film 15 acts as a seal between first electrode frame 1, second electrode frame 11 and the membrane 2 mounted therebetween.

In one exemplary embodiment of a method according to the invention, a plurality of the above-described fully integrated individual cells are first formed (for example 10 pieces). The fully integrated individual cells are then arranged one above the other, in each case with the interposition of a further adhesive film:

FIGS. 1 and 2 each illustrate a further bipolar plate 23 which is associated with an adjacent, further fully integrated individual cell (not completely illustrated) or is applied as an end plate. A third adhesive film 25 for cohesively connecting the second electrode frame 11 to the further bipolar plate 23 of the further individual cell is arranged between the further bipolar plate 23 and the second electrode frame 11 of the upper fully integrated individual cell.

In this way, a stack of individual cells which are arranged one above the other can be formed in a cost-effective manner in order to form a redox flow battery. The mechanical stability is ensured here by the adhesive films (5, 15, 25). In addition, in a further preferred embodiment, bores can be provided, for example, in the corner regions of the bipolar plates and electrode frames, it being possible for threaded rods to be passed through said bores in order to additionally press the above-described elements against one another. Two bores 7a and 7b for receiving threaded rods of this kind are identified by way of example in FIG. 1.

In an alternative exemplary embodiment, the third adhesive film (25) is replaced by a flat seal (not illustrated) (the use of a seal which is in the form of an O-ring likewise lies within the scope of the invention), and the second electrode frame (11) has a corresponding guide receptacle for spatially fixing this O-ring seal. Therefore, in this case, only elements of the fully integrated individual cell are cohesively connected to one another by the first adhesive film (5) and the second adhesive film (15). The fully integrated individual cells in the stack structure are, however, pressed against one another by the abovementioned threaded rods, wherein the respectively interposed O-ring seals provide the corresponding sealing action in relation to the liquid electrolyte, used during use, between the second electrode frame (11) of one fully integrated individual cell and the bipolar plate (23) of the adjacent fully integrated individual cell.

As described above, FIG. 2 illustrates the exploded illustration according to FIG. 1 with first electrode (4), which is arranged in the first electrode frame (1), and second electrode (14), which is arranged in the second electrode frame (11).

FIG. 3 shows a section along section line (A) in FIG. 1. The section plane here is perpendicular to the first bipolar plate (3) and therefore also perpendicular to the elements, which lie parallel to the first bipolar plate (3), first adhesive film (5), first electrode frame (1), membrane (2), second adhesive film (15), second electrode frame (11), third adhesive film (15) and further bipolar plate (23).

FIGS. 3 to 5 likewise show the view of the individual elements in a manner spaced apart from one another according to an exploded illustration for the purpose of better clarity. The individual elements actually lie directly one on the other.

As shown in FIG. 3, the membrane 2 has a distance X on both sides in relation to the outer edges of the other elements. Therefore, in particular, the second adhesive film 15 and also the two electrode frames 1 and 11 overlap the membrane 2. As a result, the membrane 2 is therefore cohesively connected to the second electrode frame 11 by the second adhesive film 15 on one side. However, similarly, the second electrode frame 11 is cohesively connected to the first electrode frame 1 at least in edge regions by the second adhesive film 15.

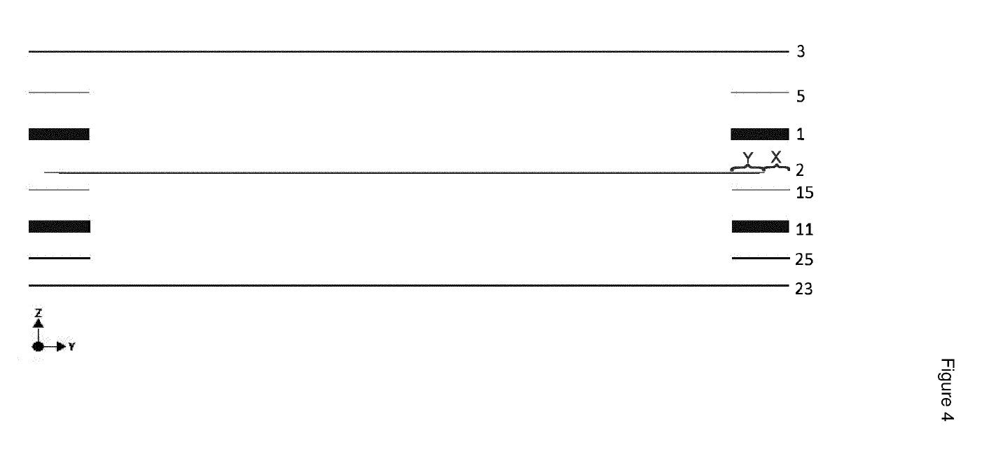

FIG. 4 shows a section according to the section line B illustrated in FIG. 1, wherein the section plane is perpendicular to the bipolar plate 3 in this case too.

This sectional illustration shows that, in the regions in which the electrode frames 1 and 11 have a cutout for receiving the electrodes, the membrane also circumferentially overlaps the electrode frames by a distance Y.

Therefore, owing to the overlap by the length Y, the membrane 2 can be cohesively connected to the electrode frame 11 by the second adhesive film 15 in a simple manner.

Furthermore, the distance X between the outer edge of the membrane 2 and the outer edge, in particular of the electrode frames (1, 11), firstly allows the use only of an adhesive film for cohesively connecting the two electrode frames and the membrane to the second electrode frame 11, as described above. Furthermore, this results in a saving in material for the membrane 2 compared to the design of a membrane of full size, for example of the size of the bipolar plate (3).

Since—as mentioned in the introductory part—the material costs of the membrane 2 make up a considerable proportion of the total costs of a redox flow cell, a significant cost saving can be achieved in this way.

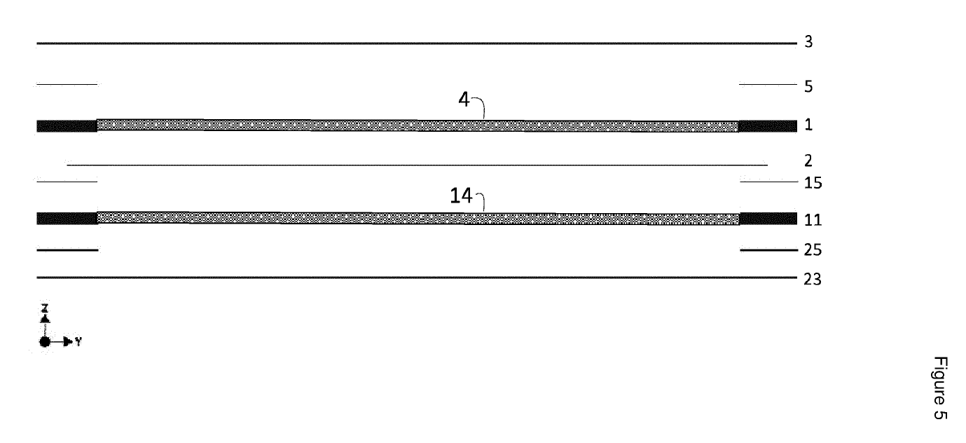

FIG. 5 shows a sectional illustration according to section line C in FIG. 2. The sectional plane is perpendicular to the bipolar plate 3 in this case too. The sectional illustration according to FIG. 5 is therefore comparable to the sectional illustration according to FIG. 4, but with the electrodes (4, 14) which are arranged in the electrode frames (1, 11) being illustrated. This figure shows that the adhesive films (5, 15 and 25) do not overlap the electrodes 4 and 14. The adhesive films therefore have the same cutout which the electrode frames also have for receiving the electrodes. Therefore, adhesive bonding of the electrodes is avoided in this way.

As shown, in particular, in FIGS. 1 and 2, the adhesive films (5, 15 and 25) form encircling, uninterrupted seals between the respectively adjacent elements and therefore act like separate O-ring seals from the prior art already known.

In particular, the bores 7a and 7b for receiving threaded rods do not completely penetrate the edge regions of the adhesive films, and therefore an encircling sealing action is ensured.

1. A component for a redox flow cell,
comprising an electrode frame (1, 11), an electrode (4, 14), a membrane (2) and a bipolar plate (3),
the electrode (4, 14) is arranged in the electrode frame (1, 11) and is circumferentially enclosed by said electrode frame, and the electrode frame (1, 11) is arranged between membrane (2) and the bipolar plate (3), and
the electrode frame (1, 11) is cohesively connected by a cohesive connection to at least the membrane (2) by adhesive bonding.

2. The component as claimed in claim 1, wherein the electrode frame (1) is additionally cohesively connected by the cohesive connection to the bipolar plate (3).

3. The component as claimed in claim 2, wherein the cohesive connection between at least one of the electrode frame (1, 11) or the bipolar plate (3) is formed by an adhesive film.

4. The component as claimed in claim 1, wherein a liquid-tight seal is formed between the electrode frame (1, 11) and the membrane (2), at least apart from one or more channels for at least one of supplying or discharging a liquid electrolyte to/from the electrode (4, 14), by the cohesive connection.

5. The component as claimed at least in claim 2, wherein a liquid-tight seal is formed between the electrode frame (1) and the bipolar plate (3), at least apart from one or more channels for at least one of supplying or discharging a liquid electrolyte to/from the electrode (4, 14), by the cohesive connection.

6. The component as claimed in claim 1, wherein the membrane (2) overlaps the electrode frame (1, 11) in an encircling manner or the membrane overlaps the frame in a direction of a length and in a direction of a width by less than 15%, with respect to the length and, respectively, the width of the frame.

7. A fully integrated individual cell comprising a component as claimed in claim 1 with the electrode frame (1) acting as a first electrode frame, the electrode (4) acting as a first electrode, the bipolar plate (3) acting as a first bipolar plate (3), the membrane (2), at least one second electrode frame (11) and one second electrode (14), the individual cell has a layer structure with indirectly or directly arranged elements having an order of the first bipolar plate, the first electrode frame (1) with the first electrode (4), the membrane (2), the second electrode frame (11) with the second electrode (14), and the cohesive connection is at least between the first bipolar plate and the first electrode frame (1), between the first electrode frame (1) and the membrane (2) and also between the membrane (2) and the second electrode frame (11).

8. The fully integrated individual cell as claimed in claim 7, wherein the electrode frame (1, 11) has channels for feeding and draining a liquid electrolyte to/from the electrode (4, 14).

9. A cell combination for a redox flow battery, comprising a plurality of fully integrated individual cells, which are arranged one above the other, as claimed in claim 8, the fully integrated individual cells are arranged one above the other and cohesively connected.

10. A method for producing a component for a redox flow cell, comprising arranging an electrode frame with an electrode (4, 14) between a membrane (2) and a bipolar plate (3), and cohesively connecting the electrode frame (1, 11) at least to the membrane (2) by adhesive bonding.

11. The method as claimed in claim 10, further comprising cohesively connecting electrode frame (1) to the bipolar plate (3).

12. The method as claimed in claim 10, further comprising forming a fully integrated individual cell by at least the bipolar plate (3) acting as a first bipolar plate being cohesively connected to the electrode frame (1) as first electrode frame, the first electrode frame being cohesively connected to the membrane (2) acting as a first membrane, and the membrane (2) being cohesively connected to a second electrode frame (11).

13. The method as claimed in claim 12, further comprising forming the integrated cell combination comprising the plurality of fully integrated individual cells by first forming the plurality of the fully integrated the individual cells and, in a subsequent method step, connecting a stack of individual cells to the bipolar plate (23) of an individual one of the cells adjacent in the combination by cohesive connection of the second electrode frame of an adjacent one of the individual cells, and, in a common method step, cohesively connecting the individual cells to one another.

14. The method as claimed in claim 12, further comprising forming the integrated cell combination by first forming the plurality of the fully integrated individual cells, said fully integrated individual cells being formed with a second bipolar plate, cohesively connecting said second bipolar plate, on that side which is averted from the membrane to the second electrode frame, and forming a plurality of intermediate elements which each comprise a first electrode frame with a first electrode, a membrane and a second electrode frame with a second electrode, and alternatively arranging one of the fully integrated individual cells and one of the intermediate elements in the integrated cell combination, with the first and last elements of the cell combination each being one of the fully integrated individual cells.

15. The method as claimed in claim 14, wherein at least the elements of the first electrode frame, the membrane and the second electrode frame of the intermediate element are cohesively connected to one another before the integrated cell combination is formed.

16. The component as claimed in claim 1, wherein the electrode frame is connected to the bipolar plate by adhesive bonding.

17. The component as claimed in claim 4, wherein the cohesive connection is an encircling liquid-tight cohesive connection that is formed between electrode frame (1, 11) and membrane (2).

18. The component as claimed in claim 5, wherein the cohesive connection is an encircling liquid-tight cohesive connection is formed between electrode frame (1) and bipolar plate (3).

19. The fully integrated individual cell of claim 7, further comprising a second bipolar plate, and a layer structure with indirectly or directly arranged elements having an order of the first bipolar plate, the first electrode frame (1) with the first electrode (4), the membrane (2), the second electrode frame (11) with the second electrode (14), the second bipolar plate, and the second bipolar plate is cohesively connected to the second electrode frame.

20. The fully integrated individual cell as claimed in claim 8, wherein the channels are formed as lines in the electrode frame (1, 11).
